(19) United States
(12) Patent Application Publication
(10) Pub. No.: US 2019/0244232 A1
(43) Pub. Date: Aug. 8, 2019

(54) TRADE REWARD METHOD, SERVER, AND STORE COMPUTER DEVICE

(71) Applicant: KAIWAY TECH CO., LTD., Taipei City (TW)

(72) Inventors: Yi-Chung LIN, Taipei City (TW); Chih-Feng HUANG, Taipei City (TW); Yung-Hsiang CHANG, Taipei City (TW)

(21) Appl. No.: 16/131,374

(22) Filed: Sep. 14, 2018

(30) Foreign Application Priority Data
Feb. 5, 2018 (TW) 107104044

(51) Int. Cl. G06Q 30/02

(52) U.S. Cl. CPC G06Q 30/0211; G06Q 30/0226

(57) ABSTRACT

A trade reward method includes the following steps of: getting a consumption amount spent in a second store by a member of a first store; calculating a reward value by multiplicating a preset ratio with the consumption amount; and transferring a first part of the reward value to an account of the first store. A server and a store computer device applied with the trade reward method are also provided.

### CROSS REFERENCE TO RELATED APPLICATIONS

This Non-provisional application claims priority under 35 U.S.C. § 119(a) on Patent Application No(s). 107104044 filed in Taiwan, Republic of China on Feb. 5, 2018, the entire contents of which are hereby incorporated by reference.

### BACKGROUND

### Technology Field

This disclosure relates to a trade reward method, a trade reward system, and a server and a store computer device of the trade reward system for multiple stores.

### Description of Related Art

In order to stimulate consumption, stores often offer discounts to consumers or give discount coupons to the consumers, thereby increasing consumers' willingness to consume again and providing incentives for repurchasing to increase store income. However, the feedback generated by this marketing method is mainly for the consumers. Although the stores increase the income as the consumers purchase in the stores, there is no extra income for the stores.

In recent years, alliance-based consumer feedback platforms (e.g., google pay) have also provided one-directional feedback services from stores to consumers. In other words, the consumers can obtain some feedbacks from stores. In this case, since the stores need to pay the reward money back to the consumers or the service platform, the stores cannot receive timely the corresponding feedback income.

Furthermore, the stores may build the alliance relation with other stores to obtain feedback income from outside of their businesses (extra reward or bonus). However, the method of purchase reward (feedback) between stores is different in the markets, and it is limited to the marketing strategies of different stores. Therefore, it is necessary to discuss between allied stores so as to jointly make the trade reward method. This will not only waste time and labor costs in the integration of different alliance stores, but also limit the number of alliance stores. Thus, the extra rewards for the alliance stores will be restricted and reduced.

Therefore, it is desired to provide a trade reward method, and the server and store computer device applied to execute the trade reward method that can integrate the trade reward of stores, so that the customer (member) of one store can also receive a certain ratio of trade reward when purchasing in other stores. Thus, the stores or the customer and the store can share the trade rewards, thereby providing the extra rewards for the stores.

### SUMMARY

In view of the foregoing, an objective of this disclosure is to provide a trade reward method, a server and a store computer device. Compared with the conventional technology, the method, server and store computer device of this disclosure can provide a trade reward between stores. When the customer (member) of one store purchases at other stores, the store can obtain the trade reward (extra bonus) according to the trade reward method. In addition, the member can also receive a trade reward in this purchase, which can encourage the member to shop in different stores.

To achieve the above, the present disclosure provides a trade reward method, comprising steps of: getting a consumption amount spent in a second store by a member of a first store; calculating a reward value by multiplicating a preset ratio with the consumption amount; and transferring a first part of the reward value to an account of the first store.

In one embodiment, the first part is obtained by multiplicating a first reward ratio with the reward value.

In one embodiment, the trade reward method further comprises steps of: calculating a second part of the reward value by multiplicating a second reward ratio with the reward value; and transferring the second part of the reward value to an account of the member.

In one embodiment, the preset ratio is between 1% and 50%.

In one embodiment, the first reward ratio or the second reward ratio is between 10% and 50%.

In one embodiment, the reward value is calculated by a server.

In one embodiment, the first part of the reward value is calculated by the server.

In one embodiment, the first part of the reward value is calculated by a store computer device.

In one embodiment, the reward value is calculated by a store computer device.

In one embodiment, the first part of the reward value is calculated by the store computer device.

In one embodiment, the first part of the reward value is calculated by a server.

In one embodiment, the account is an electronic account.

The present disclosure also provides a trade reward system comprising a store computer device and a server communicatively connected with each other. The server receives a consumption amount, which is spent in a second store by a member of a first store, from the store computer device. The server calculates a reward value by multiplicating a preset ratio with the consumption amount, and then the server transfers a first part of the reward value to an account of the first store.

In one embodiment, the first part is obtained by multiplicating a first reward ratio with the reward value.

In one embodiment, the first part of the reward value is calculated by the server.

In addition, the disclosure further provides a trade reward system comprising a server and a store computer device communicatively connected with each other. The store computer device receives a consumption amount, which is spent in a second store by a member of a first store. The store computer device calculates a reward value by multiplicating a preset ratio with the consumption amount, and then the store computer device transfers a first part of the reward value to an account of the first store.

In one embodiment, the first part is obtained by multiplicating a first reward ratio with the reward value.

In one embodiment, the first part of the reward value is calculated by the store computer device.

The disclosure also provides a server applied to a trade reward system. The trade reward system comprises the server and a store computer device, and the server and the store computer device are communicatively connected with each other. The server comprises a memory unit and a processing unit coupled with the memory unit. The memory unit stores a plurality of instructions, and the processing unit executes the instructions to perform a trade reward method. The trade reward method comprising steps of: getting a consumption amount spent in a second store by a member of a first store; calculating a reward value by multiplicating a preset ratio with the consumption amount; and transferring a first part of the reward value to an account of the first store.

The disclosure further provides a store computer device applied to a trade reward system. The trade reward system comprises a server and the store computer device, and the server and the store computer device are communicatively connected with each other. The server comprises a memory unit and a processing unit coupled with the memory unit. The memory unit stores a plurality of instructions, and the processing unit executes the instructions to perform a trade reward method. The trade reward method comprising steps of: getting a consumption amount spent in a second store by a member of a first store; calculating a reward value by multiplicating a preset ratio with the consumption amount; and transferring a first part of the reward value to an account of the first store.

As mentioned above, the trade reward method, system, server and store computer device of this disclosure can provide a trade reward between stores. When the customer (member) of one store purchases at other stores, the store can obtain the trade reward (extra bonus) according to the trade reward method. In addition, the member can also receive a trade reward in this purchase, which can encourage the member to shop in different stores. Moreover, the stores will be encouraged to actively recruit members for obtaining the trade reward so as to increase their extra incomes. Accordingly, the trade reward method, system, server and store computer device of this disclosure can provide the trade reward to the stores for increasing the extra incomes of stores, encourage the store to recruit new members, and provide the trade reward to the customers for encourage the customers to shop, thereby sharing the trade rewards between the customer and store or between the stores.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a flow chart of a trade reward method according to an embodiment of this disclosure;

FIG. 2 is a schematic diagram showing the trade reward method according to the embodiment of this disclosure;

FIG. 3 is a schematic diagram showing a trade reward system according to the embodiment of this disclosure; and

FIG. 4 is another schematic diagram of the trade reward system according to the embodiment of this disclosure.

### DETAILED DESCRIPTION OF TITLE DISCLOSURE

The present disclosure will be apparent from the following detailed description, which proceeds with reference to the accompanying drawings, wherein the same references relate to the same elements.

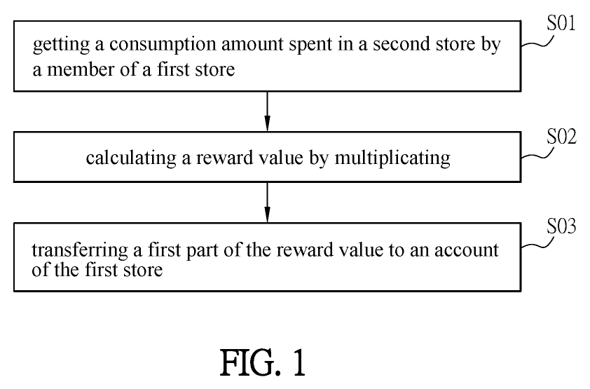

FIG. 1 is a flow chart of a trade reward method according to an embodiment of this disclosure. Referring to FIG. 1, the trade reward method of this disclosure comprises the following steps of: getting a consumption amount spent in a second store by a member of a first store (step S01); calculating a reward value by multiplicating a preset ratio with the consumption amount (step S02); and transferring a first part of the reward value to an account of the first store (step S03).

In this embodiment, the first part is obtained by multiplicating a first reward ratio with the reward value.

In the step S01 of this embodiment, the second store gets a consumption amount spent in a second store by a member of a first store.

In this embodiment, the reward value is calculated by a server or a store computer device. For example, the store computer device is a terminal device installed in the second store. In the step S01, after receiving the consumption amount, the store computer device of the second store can transmit the consumption amount to the server. Afterwards, the server can perform the step S02 to calculate a reward value by multiplicating a preset ratio with the consumption amount. Alternatively, after receiving the consumption amount, the store computer device of the second store can perform the step S02 to calculate a reward value by multiplicating a preset ratio with the consumption amount.

In this embodiment, the first part of the reward value can be calculated by the server or the store computer device. For example, after the step S02, the reward value is transmitted to the server for calculating the first part by multiplicating a first reward ratio with the reward value. Alternatively, after the step S02, the reward value is transmitted to the store computer device of the second store for calculating the first part by multiplicating a first reward ratio with the reward value.

In the step S03 of this embodiment, the first part of the reward value is transferred to an account of the first store.

In this embodiment, the trade reward method further comprises steps of: calculating a second part of the reward value by multiplicating a second reward ratio with the reward value; and transferring the second part of the reward value to an account of the member. In particular, this step can be performed between the steps S02 and S03, or after the step S03, and this disclosure is not limited.

In this embodiment, the preset ratio is between 1% and 50%. Preferably, the preset ratio is between 3% and 40%. Preferably, the preset ratio is between 5% and 30%. Preferably, the preset ratio is between 7% and 15%. More preferably, the preset ratio is 10%.

In this embodiment, the first reward ratio is between 10% and 50%. Preferably, the first reward ratio is between 20% and 45%. More preferably, the first reward ratio is between 30% and 40%.

In this embodiment, the second reward ratio is between 10% and 50%. Preferably, the second reward ratio is between 20% and 45%. More preferably, the second reward ratio is between 30% and 40%.

In this embodiment, the first reward ratio and the second reward ratio can be the same or different, and this disclosure is not limited.

In this embodiment, the reward value can be any form of feedback such as feedback money, feedback points, feedback credits, or cashes, and this disclosure is not limited.

In this embodiment, the account of the first store or the account of the member can be an electronic account, which can be, for example but not limited to, an e-bank account or an account of an electronic payment platform.

In this embodiment, the first store or the second store comprise, for example but not limited to, a physical store, a virtual store, or an individual. For example, the physical store can be a physical consumption place such as a restaurant, a cafe, a supermarket, a mass merchandise store, a department store, an entertainment place, etc. The present disclosure is not limited thereto. The virtual store can be a virtual consumption place such as an online store, an online auction store, etc. The present disclosure is not limited thereto. Herein, the first and the second are for illustrative purposes only and do not constitute limitations of the present disclosure.

In this embodiment, the member can be a normal member, a VIP member, a network member, a fan club member, or a consumer who has scanned a store's QR code. For example, when a consumer scans the QR code provided by a store with any electronic device, the consumer can be considered as a member of the store. In the present disclosure, it is merely used to exemplify that the customer is a member of the first store, and the type of the member does not constitute a limitation of the present disclosure.

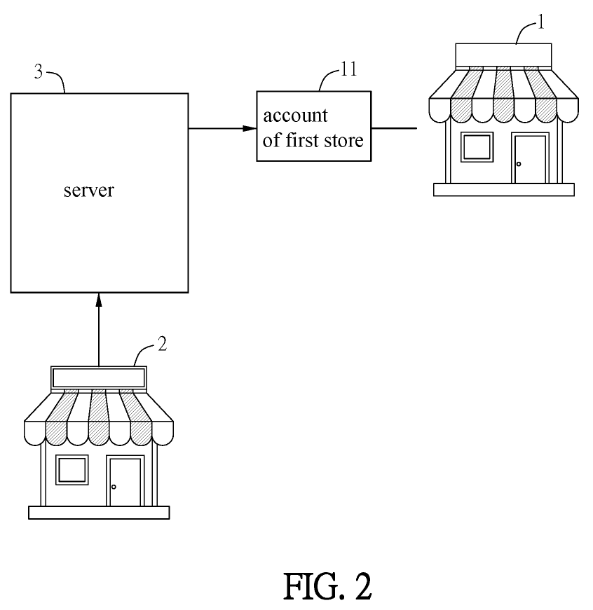

FIG. 2 is a schematic diagram showing the trade reward method according to the embodiment of this disclosure. The steps of the trade reward method of FIG. 2 can be referred to the previous embodiment, so the detailed description thereof will be omitted. In this embodiment, the second store 2 gets a consumption amount spent in a second store 2 by a member of a first store 1. Next, the second store 2 sends the consumption amount to a server 3. Then, the server 3 calculates a reward value by multiplicating a preset ratio with the consumption amount, and calculates a first part of the reward value by multiplicating a first reward ratio with the reward value. Finally, the server 3 transfers the first part of the reward value to an account 11 of the first store 1. This embodiment is only used to illustrate the preferred embodiment of the present disclosure, and does not constitute a limitation of the present disclosure.

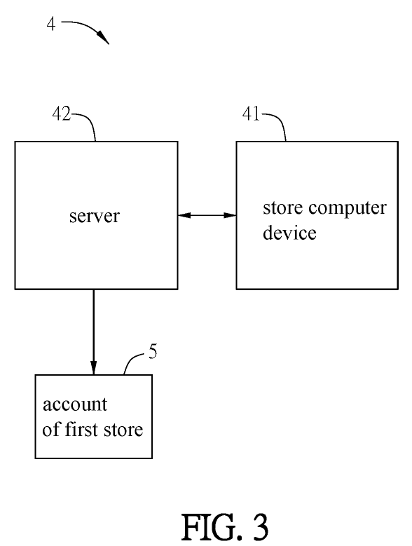

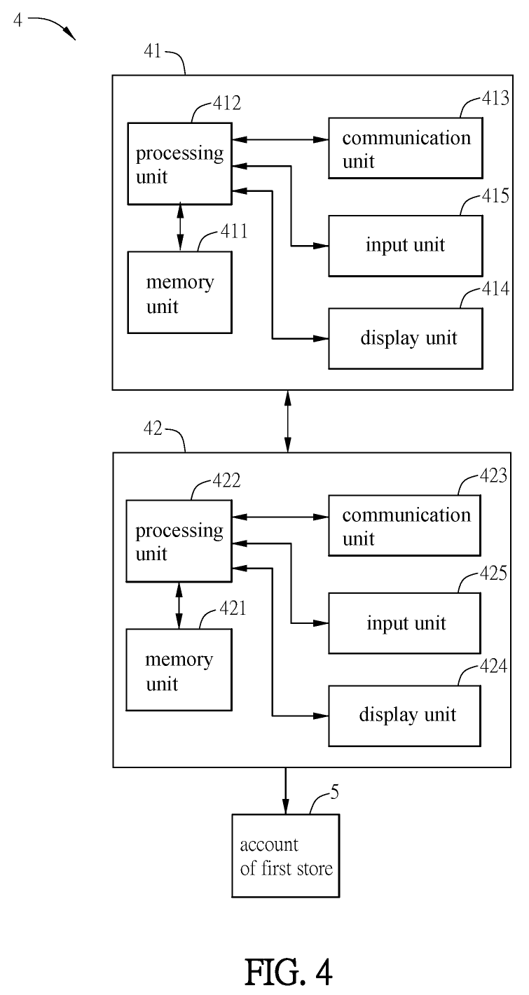

FIG. 3 is a schematic diagram showing a trade reward system 4 according to the embodiment of this disclosure, and FIG. 4 is another schematic diagram of the trade reward system 4 according to the embodiment of this disclosure. The system 4 comprises a store computer device 41 and a server 42 communicatively connected with each other. In this embodiment, the store computer device 41 and the server 42 can be communicatively connected through, for example but not limited to, a network.

In this embodiment, the server 42 receives a consumption amount, which is spent in a second store by a member of a first store, from the store computer device 41. Next, the server 42 calculates a reward value by multiplicating a preset ratio with the consumption amount, and then calculates a first part of the reward value by multiplicating a first reward ratio with the reward value. Afterwards, the server 42 transfers the first part of the reward value to an account 5 of the first store. In this embodiment, the server 42 can also calculate a second part of the reward value by multiplicating a second reward ratio with the reward value, and transfer the second part of the reward value to an account of the member.

Alternatively, the server 42 receives the consumption amount, which is spent in a second store by a member of a first store, from the store computer device 41. Next, the server 42 calculates a reward value by multiplicating a preset ratio with the consumption amount, and then sends the reward value to the store computer device 41. Then, the store computer device 41 calculates a first part of the reward value by multiplicating a first reward ratio with the reward value, and sends the first part of the reward value to the server 42. Afterwards, the server 42 transfers the first part of the reward value to an account 5 of the first store. In this embodiment, the store computer device 41 can also calculate a second part of the reward value by multiplicating a second reward ratio with the reward value and send the second part of the reward value to the server 42, and then the server 42 can transfer the second part of the reward value to an account of the member.

Alternatively, the store computer device 41 gets a consumption amount, which is spent in a second store by a member of a first store. Next, the store computer device 41 calculates a reward value by multiplicating a preset ratio with the consumption amount, and then calculates a first part of the reward value by multiplicating a first reward ratio with the reward value. Then, the store computer device 41 sends the first part of the reward value to the server 42. Afterwards, the server 42 transfers the first part of the reward value to an account 5 of the first store. In this embodiment, the store computer device 41 can also calculate a second part of the reward value by multiplicating a second reward ratio with the reward value and send the second part of the reward value to the server 42, and then the server 42 can transfer the second part of the reward value to an account of the member.

Alternatively, the store computer device 41 gets a consumption amount, which is spent in a second store by a member of a first store. Next, the store computer device 41 calculates a reward value by multiplicating a preset ratio with the consumption amount, and sands the reward value to the server 42. Then, the server 42 calculates a first part of the reward value by multiplicating a first reward ratio with the reward value. Afterwards, the server 42 transfers the first part of the reward value to an account 5 of the first store. In this embodiment, the server 42 can also calculate a second part of the reward value by multiplicating a second reward ratio with the reward value, and transfer the second part of the reward value to an account of the member.

The above embodiment indicating that the reward value, the first part and the second part can be calculated by the store computer device or the server is for an illustration only and is not to limit the disclosure. Besides, the amount (2) of the parts (including the first part and the second part) is for an illustration and is not to limit this disclosure.

Referring to FIG. 4, the store computer device 41 comprises a memory unit 411, a processing unit 412, a communication unit 413, a display unit 414, an input unit 415 and a housing (not shown). The memory unit 411, the processing unit 412 and the communication unit 413 are disposed inside the housing of the store computer device 41.

The processing unit 412 is coupled with the memory unit 411, the communication unit 413, the display unit 414, and the input unit 415, and is configured for executing instructions (e.g. program codes) to perform the above-mentioned trade reward method. The processing unit 412 is, for example, a processor for executing the instructions (e.g. program codes). The store computer device 41 may include one or more processors, and the processor can be a single-core or multi-core processor. The memory unit 411 can be any storage medium such as a random access memory or a non-volatile computer readable storage medium (e.g., a hard disk, a solid state disk (SSD), a flash memory, etc.). The memory unit 411 stores the instructions (e.g. program codes) that can be executed by the processing unit 412. In practice, the instructions (e.g. program codes) can be loaded from the non-volatile computer readable storage medium to the random access memory, and then the processing unit 412 can execute the loaded instructions. The communication unit 413 can be, for example, a network card, a network chip, a modem, or the likes that can provide a network connection. The display unit 414 includes a display card, a display chip, a display device, or the likes. The input unit 415 can be, for example, a keyboard, a mouse, or a touch screen, etc.

Referring to FIG. 4, the server 42 comprises a memory unit 421, a processing unit 422, a communication unit 423, a display unit 424, an input unit 425 and a housing (not shown). The memory unit 421, the processing unit 422 and the communication unit 423 are disposed inside the housing of the server 42.

The processing unit 422 is coupled with the memory unit 421, the communication unit 423, the display unit 424, and the input unit 425, and is configured for executing instructions (e.g. program codes) to perform the above-mentioned trade reward method. The processing unit 422 is, for example, a processor for executing the instructions (e.g. program codes). The server 42 may include one or more processors, and the processor can be a single-core or multi-core processor. The memory unit 421 can be any storage medium such as a random access memory or a non-volatile computer readable storage medium (e.g., a hard disk, a solid state disk (SSD), a flash memory, etc.). The memory unit 421 stores the instructions (e.g. program codes) that can be executed by the processing unit 422. In practice, the instructions (e.g. program codes) can be loaded from the non-volatile computer readable storage medium to the random access memory, and then the processing unit 422 can execute the loaded instructions. The communication unit 423 can be, for example, a network card, a network chip, a modem, or the likes that can provide a network connection. The display unit 424 includes a display card, a display chip, a display device, or the likes. The input unit 425 can be, for example, a keyboard, a mouse, or a touch screen, etc.

In this embodiment, the store computer device 41 of FIG. 4 can be, for example, a mobile device, a notebook computer, a desktop computer, a network device (e.g. smart appliance or smart watch), or other computer devices. Each of the mobile device, notebook computer, desktop computer, and network device includes a housing for accommodating the memory unit 411, the processing unit 412 and the communication unit 413. In the mobile device and notebook computer, the display unit 414 and the input unit 415 are installed on the housing. In the desktop computer, the display unit 414 and the input unit 415 are individual devices connected to the computer host. In the network device, the display unit 414 and the input unit 415 can be installed on the housing or individual devices connected to the host.

The server 42 can be a physical host, a physical database, a cloud host, or a cloud database. Each of the physical host, physical database, cloud host, and cloud database includes a housing for accommodating the memory unit 421, the processing unit 422 and the communication unit 423. In the physical host and physical database, the display unit 424 and the input unit 425 are installed on the housing. In the cloud host and cloud database, the display unit 424 and the input unit 425 are individual devices connected to the host.

In summary, the trade reward method, system, server and store computer device of this disclosure can provide a trade reward between stores. When the customer (member) of one store purchases at other stores, the store can obtain the trade reward (extra bonus) according to the trade reward method. In addition, the member can also receive a trade reward in this purchase, which can encourage the member to shop in different stores. Moreover, the stores will be encouraged to actively recruit members for obtaining the trade reward so as to increase their extra incomes. Accordingly, the trade reward method, system, server and store computer device of this disclosure can provide the trade reward to the stores for increasing the extra incomes of stores, encourage the store to recruit new members, and provide the trade reward to the customers for encourage the customers to shop, thereby sharing the trade rewards between the customer and store or between the stores.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A trade reward method, comprising steps of:
getting a consumption amount spent in a second store by a member of a first store;
calculating a reward value by multiplicating a preset ratio with the consumption amount; and
transferring a first part of the reward value to an account of the first store.

2. The trade reward method according to claim 1, wherein the first part is obtained by multiplicating a first reward ratio with the reward value.

3. The trade reward method according to claim 2, wherein the first reward ratio is between 10% and 50%.

4. The trade reward method according to claim 1, further comprising steps of:
calculating a second part of the reward value by multiplicating a second reward ratio with the reward value; and
transferring the second part of the reward value to an account of the member.

5. The trade reward method according to claim 4, wherein the second reward ratio is between 10% and 50%.

6. The trade reward method according to claim 4, wherein the account is an electronic account.

7. The trade reward method according to claim 1, wherein the preset ratio is between 1% and 50%.

8. The trade reward method according to claim 1, wherein the reward value is calculated by a server.

9. The trade reward method according to claim 8, wherein the first part of the reward value is calculated by the server.

10. The trade reward method according to claim 8, wherein the first part of the reward value is calculated by a store computer device.

11. The trade reward method according to claim 1, wherein the reward value is calculated by a store computer device.

12. The trade reward method according to claim 11, wherein the first part of the reward value is calculated by the store computer device.

13. The trade reward method according to claim 11, wherein the first part of the reward value is calculated by a server.

14. The trade reward method according to claim 1, wherein the account is an electronic account.

15. A server applied to a trade reward system, wherein the trade reward system comprises the server and a store computer device, the server and the store computer device are communicatively connected with each other, the server comprises a memory unit and a processing unit coupled with the memory unit, the memory unit stores a plurality of instructions, and the processing unit executes the instructions to perform a trade reward method, the trade reward method comprising steps of:
getting a consumption amount spent in a second store by a member of a first store;
calculating a reward value by multiplicating a preset ratio with the consumption amount; and
transferring a first part of the reward value to an account of the first store.

16. A store computer device applied to a trade reward system, wherein the trade reward system comprises a server and the store computer device, the server and the store computer device are communicatively connected with each other, the server comprises a memory unit and a processing unit coupled with the memory unit, the memory unit stores a plurality of instructions, and the processing unit executes the instructions to perform a trade reward method, the trade reward method comprising steps of:
getting a consumption amount spent in a second store by a member of a first store;
calculating a reward value by multiplicating a preset ratio with the consumption amount; and
transferring a first part of the reward value to an account of the first store.
